(19) United States
(12) Patent Application Publication
(10) Pub. No.: US 2026/0142367 A1
(43) Pub. Date: May 21, 2026

(54) RADOME WALL FOR COMMUNICATION APPLICATIONS

(71) Applicant: LUFTHANSA TECHNIK AG, Hamburg (DE)

(72) Inventor: Tobias Adugna, Norderstedt (DE)

(21) Appl. No.: 19/121,440

(22) PCT Filed: Oct. 13, 2023
(86) PCT No.: PCT/EP2023/078510

§ 371 Date: Apr. 16, 2025

(30) Foreign Application Priority Data
Oct. 20, 2022 (DE) 10 2022 127 708.9

(51) Int. Cl. H01Q 1/42; H01Q 1/28

(52) U.S. Cl. CPC H01Q 1/422; H01Q 1/28

(57) ABSTRACT

A radome wall for an aircraft for satellite communication in a frequency band of 17 to 31 GHz and a reception band of 17.7 to 21.2 GHz, including a multilayer structure having alternating arrangement of force-absorbing solid cover layers and shear-resistant core layers. The radome wall has an asymmetrical layer structure having a layer sequence of an outer core layer, an inner cover layer, an inner core layer, and an outer cover layer. A layer thickness of the inner cover layer is greater at least by a factor of five than a layer thickness of the outer cover layer.

### CROSS REFERENCE TO RELATED APPLICATIONS

This application is a U.S. National Phase application under 35 U.S.C. § 371 of International Application No. PCT/EP2023/078510, filed on Oct. 13, 2023, and claims benefit to German Patent Application No. DE 10 2022 127 708.9, filed on Oct. 20, 2022. The International Application was published in German on Apr. 25, 2024 as WO 2024/083680 A1 under PCT Article 21 (2).

### FIELD

The invention relates to a radome wall for communication and a radome having a corresponding radome wall.

### BACKGROUND

In general radio transmission in the frequency range from 17 to 31 GHz is used for data transmission via satellite, wherein in general the frequency range from 17.7 to 21.2 GHz is used for the transmission from a satellite to a near-earth transceiver, the so-called downlink, and the frequency range from 27.5-31 GHz is normally used for a transmission from a near-earth transceiver to a satellite (uplink). For example, a corresponding data transmission is used onboard passenger aircraft in order to be able to offer an Internet connection to the passengers during the flight.

In order to enable a corresponding data connection, antennas intended for this purpose have to be arranged on the outside of the aircraft fuselage. To protect antennas from radiation and/or to receive electromagnetic radiation from external mechanical or chemical influences, such as wind and rain, they are protected by so-called “radomes”. In addition to the structural strength required for protecting the antennas, it is essential for radomes that they have a suitable transmission behavior, thus are transmissive to a sufficient extent for the electromagnetic radiation in the frequency range relevant for the antenna(s) to be protected—for communication applications, for example, from 17 to 31 GHz.

In the case of radomes, in particular for aircraft, in which the spatial arrangement of satellites and antennas arranged on the outside of the aircraft continuously changes, but at the same time the shaping of the radome cannot be selected arbitrarily freely for aerodynamic reasons, for good data transmission, a good transmission behavior of the wall of the radome is necessary in a large range for the angles of incidence starting from orthogonal incidence of the radiation. In addition to the actual transmission properties, the least possible depolarization of the radio signals is also desirable.

In the prior art, as is disclosed, for example, in EP 2 747 202 A1 or EP 3 533 108 A1, radomes made of symmetrically constructed sandwich structures comprising GRP and foam layers are known, which, on the one hand, have adequate transmission behavior and, on the other hand, offer sufficient structural strength at low weight. Layer arrangements suitable for desired frequency ranges, in particular with regard to the thickness of the individual layers, can be calculated for this purpose, wherein the dielectric constants of the individual layer materials also have to be taken into consideration.

Even if the radome walls from EP 3 533 108 A1 in particular have very good transmission properties in the frequency range from 17 to 31 GHz and are well suitable for use on aircraft, depolarization effects occurring under very specific circumstances can require the antennas protected by such a radome to be temporarily switched off. In these rare cases, the data communication is then interrupted.

### SUMMARY

In an embodiment, the present disclosure provides a radome wall for an aircraft for satellite communication in a frequency band of 17 to 31 GHz and a reception band of 17.7 to 21.2 GHz, comprising a multilayer structure having alternating arrangement of force-absorbing solid cover layers and shear-resistant core layers. The radome wall has an asymmetrical layer structure having a layer sequence of an outer core layer, an inner cover layer, an inner core layer, and an outer cover layer. A layer thickness of the inner cover layer is greater at least by a factor of five than a layer thickness of the outer cover layer.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic section through an embodiment of a radome wall according to the present disclosure; and

FIGS. 2a-2c show diagrams of transmission and depolarization properties of the radome wall from FIG. 1.

### DETAILED DESCRIPTION

In an embodiment, the present disclosure provides a radome wall in which the disadvantages from the prior art no longer occur or at least only still occur to a reduced extent.

Accordingly, the present disclosure relates to a radome wall for satellite communication in the frequency band from 17 to 31 GHz, in particular in the reception band from 17.7 to 21.2 GHz and in the transmission band from 27.5 to 31 GHz, for use on aircraft comprising a multilayer structure having alternating arrangement of force-absorbing solid cover layers and shear-resistant core layers, wherein the radome wall has an asymmetrical layer structure having the layer sequence outer core layer-inner cover layer-inner core layer-outer cover layer, wherein the layer thickness of the inner core layer is greater by at least a factor of five than the layer thickness of the outer core layer.

The present disclosure furthermore relates to a radome for use on aircraft, the wall of which is designed according to the present disclosure.

First, several terms used in the course of the present disclosure will be explained:

The “cover layers” are force-absorbing solid layers of a multilayer structure, while “core layers” are only shear-resistant, wherein the specific weight of the cover layer is as a result often higher than the specific weight of the core layers. Adjacent layers of the multilayer structure are firmly connected to one another, in particular in a shear-resistant manner, for example, adhesively bonded with one another, wherein in general an interposed core layer is provided between two cover layers in order to keep the cover layers spaced apart. The sandwich structure—although also regularly having two outer cover layers—is widespread and known in the prior art, not only with respect to radomes.

One layer of a multilayer structure is considered to be “inner” in this case if further layers of the multilayer structure are arranged on both sides of the layer in question. One layer of a multilayer structure is accordingly considered to be “outer” if no further layer of the multilayer structure is arranged on one side of the layer in question. In the assignment of a layer as inner or outer, only further structural layers of the multilayer structure itself are taken into consideration, but not layers which do not contribute to the mechanical structure of the multilayer structure, such as paint layers or comparable coatings. Since corresponding coatings can certainly have influence on the transmission properties of the radome wall, however, they can be taken into consideration in the ascertainment of the thicknesses and/or the selection of the dielectric constants of the individual layers of the multilayer structure.

The radome wall according to the present disclosure is especially designed for use on aircraft and is distinguished by an asymmetrical layer sequence made up of core layer-cover layer-core layer-cover layer, wherein the outer cover layer has a significantly lesser thickness than the inner cover layer. As a result, the fundamental structural integrity of the radome wall according to the present disclosure is decisively ensured by the inner cover layer, in particular in the case of greater mechanical stresses as occur due to the flow around the radome wall during a flight. The outer, significantly thinner cover layer is primarily used to protect the core layer adjacent thereto from smaller mechanical stresses, such as hail or the striking of smaller particles entrained by the flow around the radome wall, such as grains of sand. A corresponding protection from mechanical stress on the other side of the radome wall facing toward the antennas is not required and is also not provided according to the present disclosure. In the case of greater energetic impact stresses, for example, due to bird strike, the fundamental structural integrity of the radome wall is ensured by the inner cover layer.

It is recognized by the present disclosure that by using a radome wall designed according to the present disclosure having asymmetrical structure for use on aircraft, in which the inner cover layer has a significantly greater thickness-namely at least by a factor of five—in comparison to the outer cover layer, not only good transmission properties, but also a low depolarization can be achieved with mechanical properties suitable for the intended use at the same time, in particular the required structural strength.

It is preferred if the layer thickness of the inner cover layer is greater by at least a factor of six, preferably by at least a factor of seven than the layer thickness of the outer cover layer. It has been shown that the transmission and depolarization properties can be further improved if the thickness ratio of the two cover layers is shifted further in favor of the inner cover layer, wherein it is to be ensured at the same time with regard to the intended use on the outside of aircraft that the outer cover layer can fulfill its protective function from smaller mechanical stresses, and the total weight of the radome wall, which is regularly influenced to a not insignificant part by the total thickness of the two cover layers, remains as low as possible.

With regard to the transmission and depolarization properties, it has further proven to be advantageous if the layer thickness of the inner core layer is less than the layer thickness of the outer core layer.

Preferably, the layer thickness of the inner cover layer is between 3.5 mm and 3.9 mm, preferably between 3.8 mm and 3.9 mm, more preferably 3.85 mm, the layer thickness of the outer cover layer is between 0.5 mm and 0.6 mm, preferably 0.55 mm, the layer thickness of the inner core layer is between 1.8 mm and 2.0 mm, preferably 1.9 mm, and the layer thickness of the outer core layer is between 2.5 mm and 2.9 mm, preferably 2.7 mm. Alternatively or additionally, a tolerance of +0.2 mm, preferably of +0.1 mm, more preferably of +0.05 mm can be provided for the layer thicknesses.

In addition to the thicknesses of the individual layers, the dielectric constants of the individual layers can also influence the transmission and depolarization properties of the radome wall. It has proven to be advantageous here if the dielectric constant of each of the cover layers is greater than the respective dielectric constant of the core layers. The dielectric constants of the cover layers can each be between 2.6 and 2.9 here, preferably between 2.7 and 2.9, more preferably at 2.8, the dielectric constant of the inner core layer between 1.7 and 1.9, preferably at 1.8, and/or the dielectric constant of the outer core layer between 1.1 and 1.4, preferably between 1.15 and 1.35, more preferably at 1.25.

The dielectric constants can be selected differently for each of the layers of the radome wall. However, the dielectric constants of the two cover layers are preferably identical to one another. Corresponding identical dielectric constants already regularly result due to the use of identical materials for the cover layers, which can also mean a simplification of the production at the same time. In particular the dielectric constants of the two core layers regularly have to be different, however. Significant differences in the dielectric constants of the core layers have proven to be particularly advantageous here. Independently of the specific dielectric constants, it is preferred if the dielectric constant of the inner core layer is greater by at least a factor of 1.3, preferably at least by a factor of 1.4, than the dielectric constant of the outer core layer.

The cover layers can each be formed by one or more layers made of prepreg material, preferably quartz glass fiber/epoxy prepreg. The core layers are preferably formed by foam material, preferably made of polyurethane hard foam.

Reference is made to the preceding statements for the explanation of the radome according to the present disclosure.

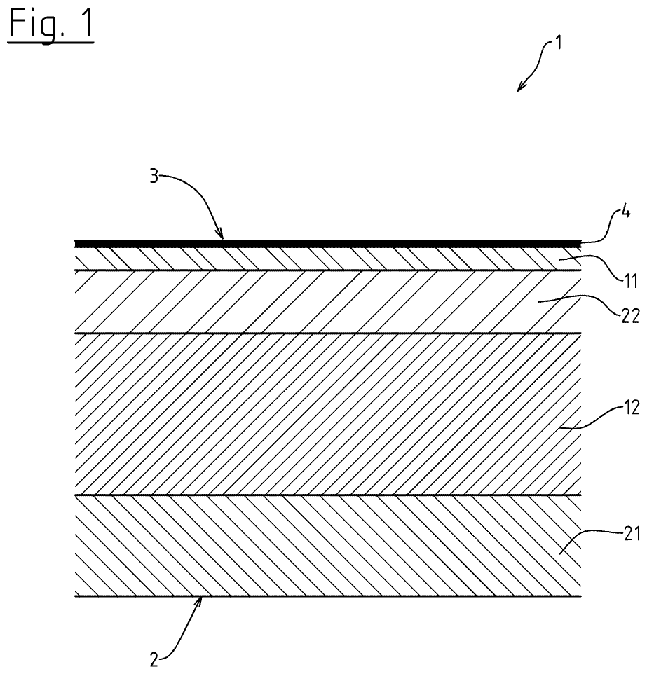

FIG. 1 shows a first exemplary embodiment of a radome wall 1 according to the present disclosure for communication, in particular data transmission, in the frequency band from 17 to 31 GHz for use on aircraft in a sectional view.

The radome wall 1 comprises two cover layers 11, 12 and two core layers 21, 22. Starting from the side 2 of the radome wall 1, which faces toward the antenna to be protected from external influences during normal use—in series—an outer core layer 21, an inner cover layer 12, an inner core layer 22, and an outer cover layer 11 are provided. A surface coating 4 for more extensive protection can also be provided in the usage state of the side 3 of the radome wall 1 facing away from the antenna to be protected. However, since this is not an integral structural component of the radome wall 1, in principle it is only taken into consideration with regard to the transmission properties of the radome wall 1. Impairment of the transmission properties of the radome wall 1 possibly to be expected due to the surface coating 4 can be reduced or avoided if needed, however, by suitable selection of another surface coating 4 and/or possible adaptation of the layer thicknesses and/or dielectric constants of the individual cover and core layers 11, 12, 21, 22.

In the illustrated exemplary embodiment, the surface coating 4 comprises a multilayer material application, comprising the following layers:

| | | |
|---|---|---|
| Layer | Thickness | Dielectric constant |

| | | | |
|---|---|---|---|
| Antistatic layer | 0.02 | mm | 0.05 |
| Primer | 0.025 | mm | 3.4 |
| Topcoat | 0.1 | mm | 3.5 |

The cover layers 11, 12 are formed from quartz glass fiber/epoxy resin prepreg, while the core layers 21, 22 are formed from a polyurethane hard foam.

The thickness of the individual cover layers 11, 12 and core layers 21, 22 as well as their respective dielectric constants result from the following table:

| Layer | Thickness | Dielectric constant |
|---|---|---|
| 21 | 2.70 mm | 2.8 |
| 12 | 3.85 mm | 1.8 |
| 22 | 1.90 mm | 2.8 |
| 11 | 0.55 mm | 1.25 |

For the specified thicknesses, a tolerance of ±0.2 mm, preferably ±0.1 mm can be provided.

As directly results from the preceding table, the thickness of the inner cover layer 12 is greater by a factor of seven than the thickness of the outer cover layer 11. In addition, the thickness of the inner core layer 22 is less than the thickness of the outer core layer 21.

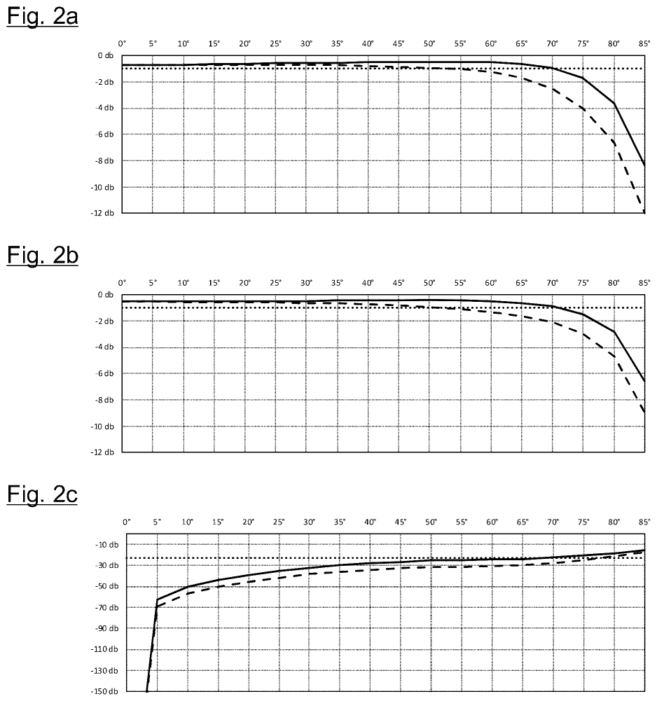

FIGS. 2a-c show the transmission and depolarization properties of the radome wall 1 according to FIG. 1 depending on the angle of incidence starting from an orthogonal incidence of the radiation, i.e. an angle of 0° means orthogonal incidence.

FIG. 2a shows the transmission properties of the radome wall 1 in the transmission band of 27.5 to 31 GHz, which is relevant for satellite communication, depending on the angle of incidence, specifically as the transmission loss in [dB] of both the electric (dashed line) and the magnetic (solid line) components of the electromagnetic radiation. Up to an angle of incidence of 60° starting from orthogonal incidence of the radiation, the transmission loss for both the electric and the magnetic component is less than or hardly more than 1 dB (dotted line). Up to an angle of incidence of 70°, the transmission losses are sufficiently low that satellite communication—or the transmission here—is often still possible even up to this angle of incidence.

FIG. 2b is comparable to FIG. 2a, but shows the transmission properties of the radome wall 1 in the reception range of 17.7 to 21.2 GHz, which is relevant for satellite communication, depending on the angle of incidence. The transmission losses up to an angle of incidence of 60° starting from orthogonal incidence of the radiation both for the electric (dashed line) and the magnetic component (solid line) are less or hardly more than 1 dB here (dotted line). At an angle of incidence of 70°, only the transmission loss for the electrical component of the electromagnetic radiation is greater than 1 dB; nonetheless, a satellite communication—or the reception here—is regularly still possible even at such an angle of incidence.

FIG. 2c shows the depolarization properties of the radome wall 1 both for the transmission band of 27.5 to 31 GHz, which is relevant in satellite communication (solid line), and for the corresponding reception band of 17.7 to 21.2 GHz (dashed line) depending on the angle of incidence. The depolarization properties are depicted here as the “cross polarization discrimination” value (XPD value). As is immediately apparent from FIG. 2c, the depolarization properties are below a critical value of −23 dB (dotted line) and are therefore to be classified as outstanding both in the transmission band and in the reception band up to an angle of incidence of up to 65°. The depolarization properties are still to be designated as very good at 70°.

The consideration of FIGS. 2a-c together therefore has the result that the radome wall 1 according to FIG. 1 has outstanding transmission and depolarization properties up to an angle of incidence of 60° starting from orthogonal incidence of the radiation and still has very good transmission and depolarization properties up to an angle of incidence of at least 65° or 70°. At the same time, the radome wall 1 has sufficient structural properties, which permit a usage of the radome wall on the outside of aircraft, in particular commercial or passenger aircraft.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A radome wall for an aircraft for satellite communication in a frequency band of 17 to 31 GHz and a reception band of 17.7 to 21.2 GHz, comprising:
a multilayer structure having alternating arrangement of force-absorbing solid cover layers and shear-resistant core layers,
wherein the radome wall has an asymmetrical layer structure having a layer sequence of an outer core layer, an inner cover layer, an inner core layer, and an outer cover layer, and
wherein a layer thickness of the inner cover layer is greater at least by a factor of five than a layer thickness of the outer cover layer.

2. The radome wall as claimed in claim 1, wherein the layer thickness of the inner cover layer is greater at least by a factor of six than the layer thickness of the outer cover layer.

3. The radome wall as claimed in claim 1, wherein a layer thickness of the inner core layer is less than a layer thickness of the outer core layer.

4. The radome wall as claimed in claim 1, wherein the layer thickness of the inner cover layer is between 3.5 mm and 3.9 mm, the layer thickness of the outer cover layer is between 0.5 mm and 0.6 mm, a layer thickness of the inner core layer is between 1.8 mm and 2.0 mm, and a layer thickness of the outer core layer is between 2.5 mm and 2.9 mm.

5. The radome wall as claimed in claim 1, wherein a dielectric constant of each of the inner and outer cover layers is greater than a respective dielectric constant of the inner and outer core layers.

6. The radome wall as claimed in claim 1, wherein a dielectric constant of the inner core layer is greater by at least a factor of 1.3, than a dielectric constant of the outer core layer.

7. The radome wall as claimed in claim 1, wherein a dielectric constant of the inner and outer cover layers are each between 2.6 and 2.9, a dielectric constant of the inner core layer is between 1.7 and 1.9, and/or a dielectric constant of the outer core layer is between 1.1 and 1.4.

8. The radome wall as claimed in claim 1, wherein a dielectric constant of each of the inner and outer cover layers is identical and a dielectric constant of each of the inner and outer core layers is different.

9. The radome wall as claimed in claim 1, wherein the inner and outer cover layers are each formed by one or more layers made of prepreg material.

10. The radome wall as claimed in claim 1, wherein the inner and outer core layers are each formed by foam material.

11. A radome for an aircraft, comprising the radome wall as claimed in claim 1.

12. The radome wall as claimed in claim 2, wherein the layer thickness of the inner cover layer is greater at least by a factor of seven than the layer thickness of the outer cover layer.

13. The radome wall as claimed in claim 4, wherein the layer thickness of the inner cover layer is between 3.8 and 3.9 mm, the layer thickness of the outer cover layer is 0.55 mm, the layer thickness of the inner core layer is 1.9 mm, and the layer thickness of the outer core layer is 2.7 mm.

14. The radome wall as claimed in claim 6, wherein the dielectric constant of the inner core layer is greater by at least a factor of 1.4 than the dielectric constant of the outer core layer.

15. The radome wall as claimed in claim 7, wherein the dielectric constant of the inner and outer cover layers are each between 2.7 and 2.9, the dielectric constant of the inner core layer is 1.8, and the dielectric constant of the outer core layer is between 1.15 and 1.35.

16. The radome wall as claimed in claim 9, wherein the prepreg material is quartz glass fiber/epoxy prepreg.

17. The radome wall as claimed in claim 9, wherein a thickness of the prepreg is 0.275 mm.

18. The radome wall as claimed in claim 10, wherein the foam material is polyurethane hard foam.
